(19) United States
(12) Patent Application Publication
(10) Pub. No.: US 2025/0302582 A1
(43) Pub. Date: Oct. 2, 2025

(54) APPARATUS AND METHOD FOR PRECISION OSTEOTOMY TO SUPPORT TRANSALVEOLAR DENTAL IMPLANT PLACEMENT WITH LIMITED INTEROCCLUSAL SPACE

(71) Applicant: INDIVIDUAL IMPLANT SOLUTIONS, INC., Woodland Hills, CA (US)

(72) Inventor: Robert G. HALE, Woodland Hills, CA (US)

(73) Assignee: INDIVIDUAL IMPLANT SOLUTIONS, INC., Woodland Hills, CA (US)

(21) Appl. No.: 19/061,322

(22) Filed: Feb. 24, 2025

Related U.S. Application Data
(60) Provisional application No. 63/572,034, filed on Mar. 29, 2024.

(51) Int. Cl. A61C 1/08

(52) U.S. Cl. CPC A61C 1/084

(57) ABSTRACT

A dental implant guidance apparatus includes a fixation plate including a contoured portion attached to a planar portion, an alignment sleeve disposed on the contoured portion, a security feature disposed on the contoured portion, and an aperture disposed on the planar portion; and a drill guidance apparatus including an engagement surface attached to an extension arm, the engagement surface configured to abut the contoured portion of the fixation plate, an alignment pin disposed on the engagement portion and configured to be inserted into the alignment sleeve, the alignment pin protruding from the engagement surface, an attachment feature disposed on the engagement portion, the attachment feature configured to couple with the security feature, and a guidance tube disposed on the extension arm, the guidance tube configured to receive an object therein through a length of the guidance tube.

### CROSS-REFERENCE TO RELATED APPLICATIONS

The present application claims priority to U.S. Provisional Application No. 63/572,034, filed Mar. 29, 2024, the entire content of which is incorporated by reference herein in its entirety for all purposes.

### BACKGROUND

### Field of the Disclosure

The present disclosure relates to a drill guidance apparatus and a method for using the guidance apparatus for a precision osteotomy. In particular, a transalveolar dental implant can be positioned and affixed in clinical environments constrained by limited interocclusal space.

### Description of the Related Art

Some dental implants replace missing teeth with root-form analogs which include titanium devices shaped in bone screws surgically placed into dentoalveolar structures with specialized platforms protruding through the crest of the dentoalveolus to mount dental prostheses. The dental implants are screwed through the crest of the dentoalveolus after drills prepare an osteotomy of appropriate diameter and length to receive the bone screw portion of a dental implant.

The foregoing description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a dental implant guidance apparatus, including a fixation plate including a contoured portion attached to a planar portion, an alignment sleeve disposed on the contoured portion, the alignment sleeve being an opening extending at least partially into the contoured portion of the fixation plate, a security feature disposed on the contoured portion, and an aperture disposed on the planar portion; and a drill guidance apparatus including an engagement surface attached to an extension arm, the engagement surface configured to abut the contoured portion of the fixation plate, an alignment pin disposed on the engagement portion and configured to be inserted into the alignment sleeve, the alignment pin protruding from the engagement surface, an attachment feature disposed on the engagement portion, the attachment feature configured to couple with the security feature, and a guidance tube disposed on the extension arm, the guidance tube configured to receive an object therein through a length of the guidance tube, wherein upon coupling the drill guidance apparatus to the fixation plate, the alignment pin is inserted into the alignment sleeve, the attachment feature is coupled to the security feature, and the guidance tube is aligned with the aperture of the planar portion of the fixation plate.

In one embodiment, the present disclosure is additionally related to a method of performing an osteotomy, including attaching a fixation plate to skeletal bone, the fixation plate being disposed at least partially in dentoalveolar bone; inserting a drill bit through a guidance tube of a drill guidance apparatus; coupling the drill guidance apparatus to the fixation plate, the fixation plate including (i) a contoured portion attached to a planar portion, (ii) an alignment sleeve disposed on the contoured portion, the alignment sleeve being an opening extending at least partially into the contoured portion of the fixation plate, (iii) a security feature disposed on the contoured portion, and (iv) an aperture disposed on the planar portion, the drill guidance apparatus including (i) an engagement surface attached to an extension arm, the engagement surface configured to abut the contoured portion of the fixation plate, (ii) an alignment pin disposed on the engagement portion and configured to be inserted into the alignment sleeve, the alignment pin protruding from the engagement surface, (iii) an attachment feature disposed on the engagement portion, the attachment feature configured to couple with the security feature, (iv) the guidance tube disposed on the extension arm, the guidance tube configured to receive the drill bit therein through a length of the guidance tube, and (v) an extension plate attached to the engagement surface, the extension plate including an aperture, the drill guidance tube being aligned with the aperture of the extension plate; forming, using the drill bit, a first opening in the dentoalveolar bone; removing the extension arm and the drill bit; securing a guidance rod to the aperture of the extension plate through the first opening; adjusting, using a hollow drill bit inserted over the guidance rod via a hollow portion of the hollow drill bit, a diameter and sidewall structure of the first opening; removing the hollow drill bit, guidance rod, and drill guidance apparatus; and securing a dental implant to the aperture of the planar portion of the fixation plate through the adjusted first opening.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a schematic of the drill guidance apparatus (or system), according to an embodiment of the present disclosure.

FIG. 2 shows a 2D schematic of a jaw, according to an embodiment of the present disclosure.

FIG. 3 shows a perspective view schematic of a jaw partially open, according to an embodiment of the present disclosure.

FIG. 4 shows a schematic of a dental implant.

FIG. 5 shows a schematic of a dental drill with various drill bit sizes, according to an embodiment of the present disclosure.

FIG. 6 shows a magnified image of a dental implant, according to an embodiment of the present disclosure.

FIG. 7 shows a schematic of progressing bone formation and implant stability, according to an embodiment of the present disclosure.

FIG. 8 shows a schematic for various drill steps to implant a dental implant, according to an embodiment of the present disclosure.

FIG. 9 shows schematics of implants and corresponding bone types, according to an embodiment of the present disclosure.

FIG. 10 shows schematics of Bone-in-Contact for a screw, according to an embodiment of the present disclosure.

FIG. 11 shows a schematic of a roughened dental implant surface, according to an embodiment of the present disclosure.

FIG. 12 shows a schematic of a drill performing an osteotomy, according to an embodiment of the present disclosure.

FIG. 13 shows a schematic of a drill guide attached to a tooth.

FIG. 14 shows the drill guide limiting depth and angle of attack.

FIG. 15 shows a schematic of a CT image, according to an embodiment of the present disclosure.

FIG. 16 is a schematic of the TDI system, according to an embodiment of the present disclosure.

FIG. 17 is a schematic of the TDI system engaged in a skull, according to an embodiment of the present disclosure.

FIG. 18 shows a schematic of the TDI system including a dental post with a threaded apex engaged therein, according to an embodiment of the present disclosure.

FIG. 19 shows a schematic of templates for drilling screw holes, according to an embodiment of the present disclosure.

FIG. 20 shows a schematic of the TDI system engaged after a channel osteotomy, according to an embodiment of the present disclosure.

FIG. 21 shows a schematic of the TDI system engaged after a vertical osteotomy, according to an embodiment of the present disclosure.

FIGS. 22 to 24J show schematics of the drill guidance apparatus, according to an embodiment of the present disclosure.

FIGS. 25A and 25B show schematics of a custom lower molar TDI (LM-TDI), according to an embodiment of the present disclosure.

FIG. 26 shows a schematic of a drill guidance apparatus, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

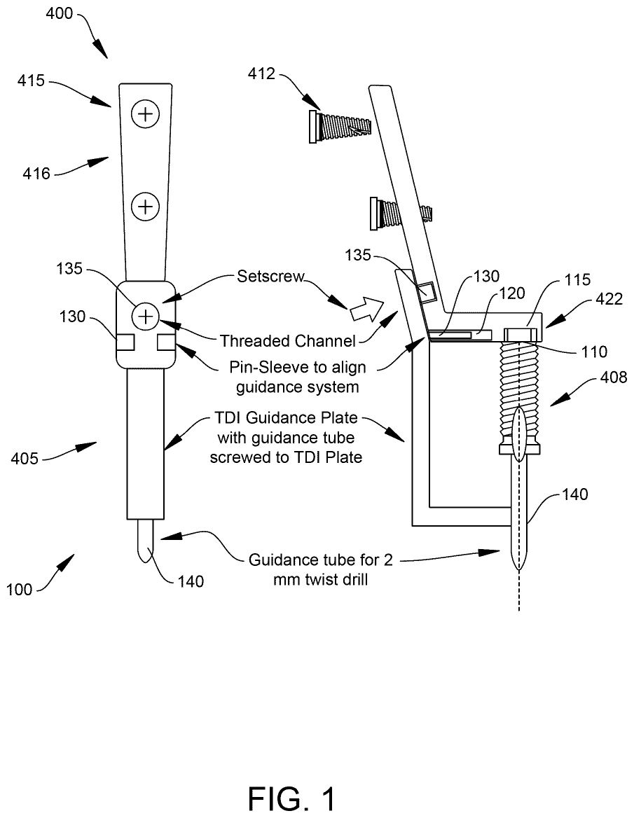

Described herein is a drill guidance apparatus. FIG. 1 shows a schematic of the drill guidance apparatus (or system) 100, according to an embodiment of the present disclosure. In an embodiment, the drill guidance apparatus 100 includes a guidance plate 105 (or alignment plate) that can be fastened, attached, or secured to alignment features of a Transalveolar Dental Implant (TDI) bone plate 400.

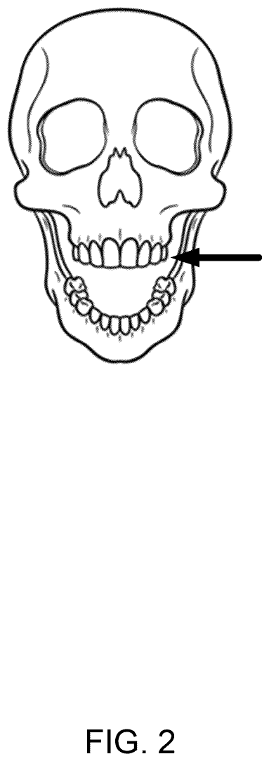

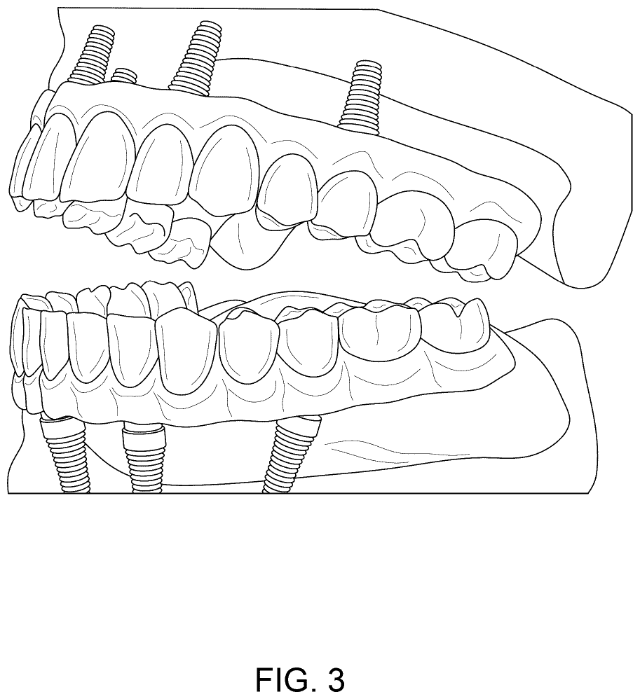

FIG. 2 shows a 2D schematic of a jaw, according to an embodiment of the present disclosure. FIG. 3 shows a perspective view schematic of a jaw partially open, according to an embodiment of the present disclosure. In an embodiment, the drill guidance apparatus 100 can be designed to be arranged and secured to the bone plate 400 from a lateral approach, which is indicated by the arrow in FIG. 2. The lateral approach can be used in clinical situations of limited interocclusal space, highlighted by FIG. 3 with the partially opened jaw. The drill guidance apparatus 100, once attached or secured to the TDI bone plate 400, can direct a series of drills to precisely perform an osteotomy from the crest of the dentoalveolar ridge to a corresponding threaded aperture 110 (see FIG. 1) of an embedded TDI bone plate, which will subsequently receive the threaded apex of a dental implant 115.

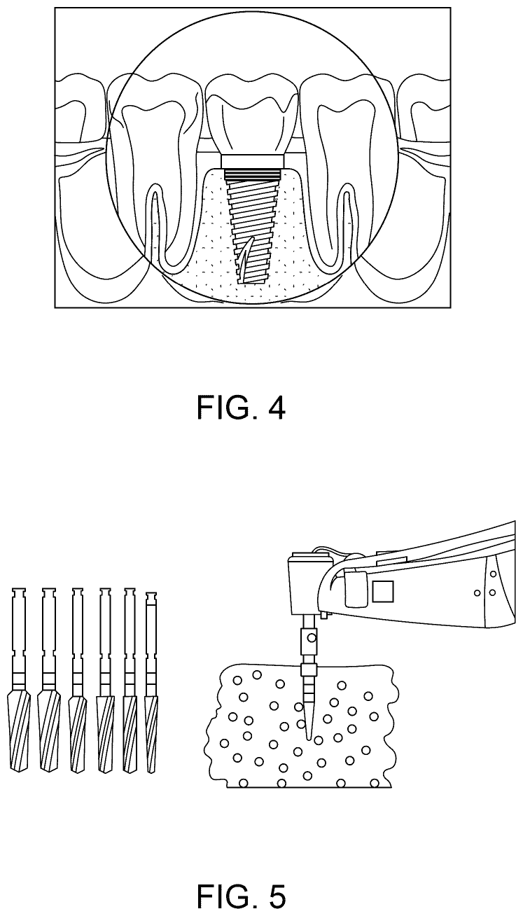

FIG. 4 shows a schematic of a dental implant. Some dental implants 4005 replace missing teeth with root-form analogs which can include titanium devices shaped in bone screws surgically placed into dentoalveolar structures 4010 with specialized platforms 4015 protruding through the crest of the dentoalveolus to mount dental prostheses 4020.

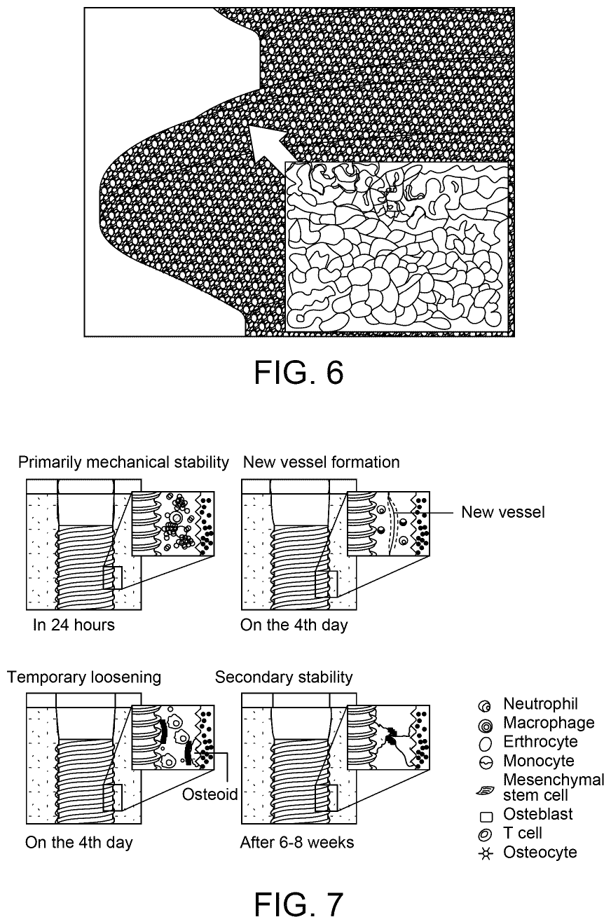

FIG. 5 shows a schematic of a dental drill with various drill bit sizes, according to an embodiment of the present disclosure. In an embodiment, the dental implants 4005 can be screwed through the crest of the dentoalveolus after drills prepare an osteotomy of appropriate diameter and length to receive the bone screw portion of a dental implant.

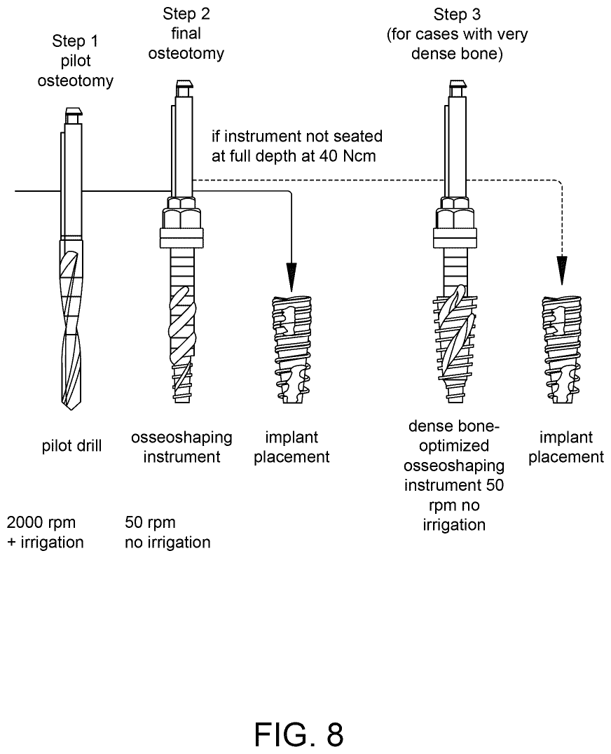

FIG. 6 shows a magnified image of a dental implant, according to an embodiment of the present disclosure. In an embodiment, dental implants implanted into the dentoalveolar bone can seek to establish primary stability upon implantation. The primary stability allows for bone formation to occur between the surface of a dental implant shown in FIG. 6, which can be formed of a roughened titanium alloy (Ti-6Al-4V) and native bone tissue exposed during the drilling of an osteotomy.

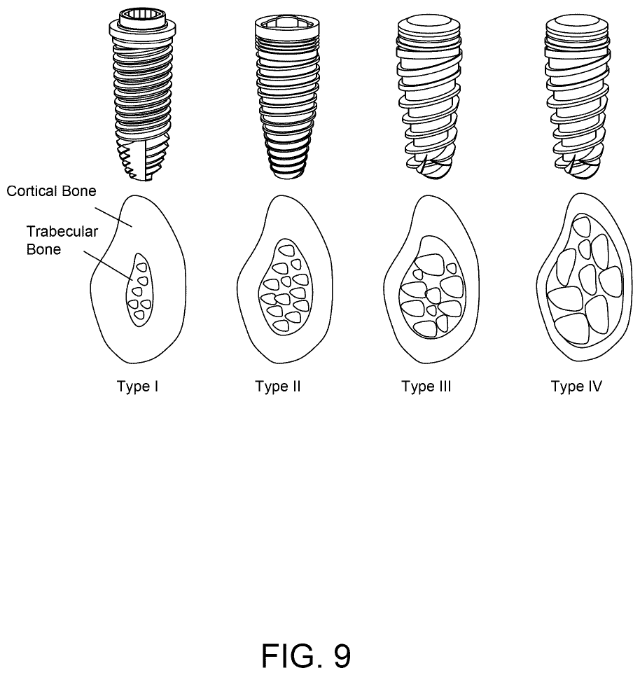

To this end, FIG. 7 shows a schematic of progressing bone formation and implant stability, according to an embodiment of the present disclosure. In an embodiment, a gap between the dental implant and native bone can be filled with a blood clot 4025 and platelets in the blood clot release growth factors. Within days of the osteotomy, neovascularization 4030 occurs as the body's initial response to heal the osteotomy site occupied by a stable titanium dental implant. Within 6 to 8 weeks of surgery, bone 4035 starts to bridge the gap between the surface of the dental implant and the native bone. The bone bridges then mature to establish dental implant secondary stability, which is also referred to as dental implant osteointegration 4040.

When primary stability is not established due to excessive micromotion of the dental implant (over 100 um), then neovascularization can be disrupted, and bone formation can be prevented. The result will be fibrous tissue formation in the gap between the dental implant and bone, with eventual failure of the dental implant under functional occlusal loads. Primary stability of the dental implant 4005 for approximately 8 weeks can therefore provide or signal clinical success.

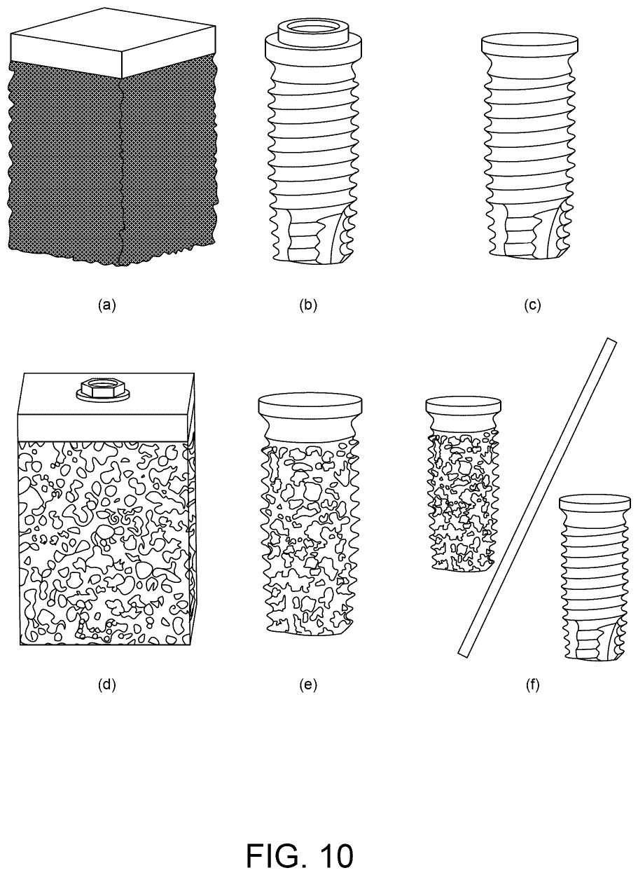

FIG. 8 shows a schematic for various drill steps to implant a dental implant, according to an embodiment of the present disclosure. In an embodiment, the screw design of some dental implants, like the dental implant 4005, provides the mechanical forces to compress native bone between the screw threads as the larger diameter dental implant is torqued into an osteotomy hole drilled to accommodate the dental implant. Depending on the clinically estimated bone density, the hole drilled can be sized accordingly: soft alveolar bone can correspond to osteotomy holes under-drilled substantially (second and third drill bits) compared to alveolar bone denser in composition and therefore drilled wider (fourth and fifth drill bits). The screw design, likewise, can be modified to enhance the screw engagement of the bone with the overall goal of developing adequate primary stability to prevent excess micromotion of the dental implant while the bone heals. Also operative in the surgical placement of a dental implant is judicial use of insertional torque to prevent excessive microfracturing of the bone as the dental implant threads engages the bone. Mitigation of friction during drilling or implant insertion is also important to prevent elevation of tissue temperatures to detrimental levels. Over-compressed or thermally damaged bone precludes the necessary biological conditions for osteointegration.

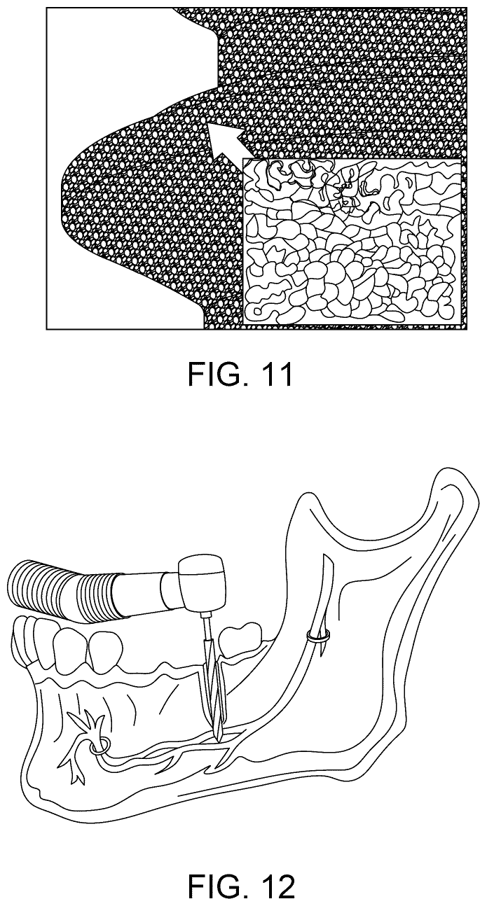

FIG. 9 shows schematics of implants and corresponding bone types, according to an embodiment of the present disclosure. In an embodiment, an additional requirement of dental implant clinical success can be adequate Bone-in-Contact with the (titanium) device to achieve secondary stability to resist occlusal forces. This can be achieved with use of macro and microgeometry of the titanium surface to increase the effective surface area.

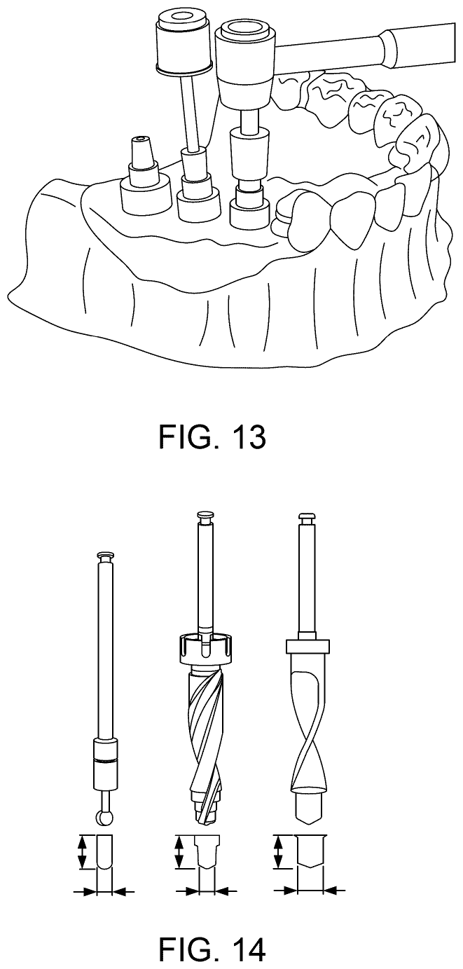

To this end, FIG. 10 shows schematics of Bone-in-Contact for a screw, according to an embodiment of the present disclosure. In an embodiment, to maximize the Bone-in-Contact, the dental implant can be shaped into screws which vary between 3 mm in diameter and 7 mm in length, to as much as 5 mm in diameter and 18 mm in length, which can be dependent on the size and bone density of the dentoalveolus.

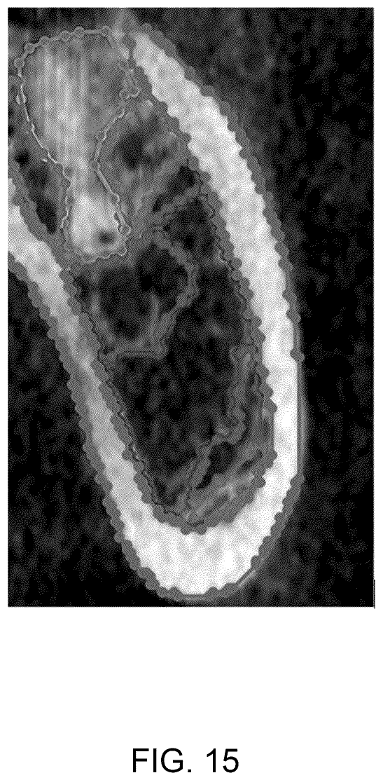

FIG. 11 shows a schematic of a roughened dental implant surface, according to an embodiment of the present disclosure. In an embodiment, the surface texture of the intraosseous portion of the dental implant can be roughened, which increases the Bone-in Contact.

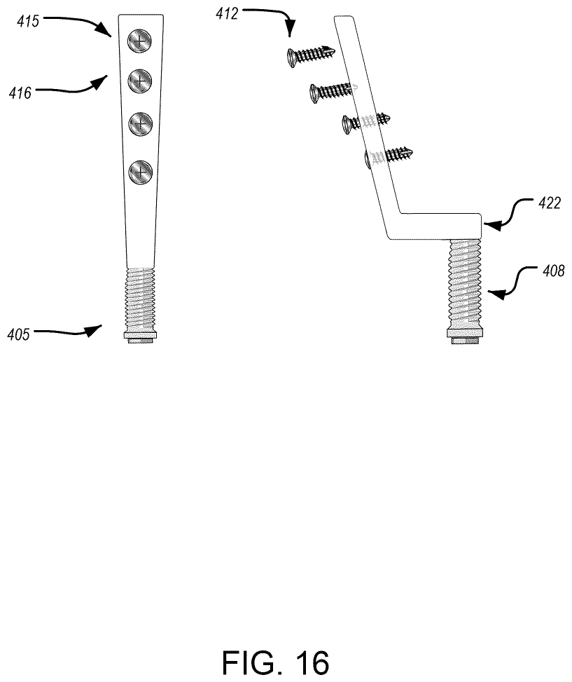

FIG. 12 shows a schematic of a drill performing an osteotomy, according to an embodiment of the present disclosure. In an embodiment, the type, diameter, and sequence of the drills used can be a clinical estimate to match the dental implant type and size with the goal of obtaining primary stability. Additionally, drills used to perform the osteotomy can be aimed from a predetermined point on the dentoalveolar crest to a predetermined depth and alignment for a subsequently inserted and properly positioned dental implant.

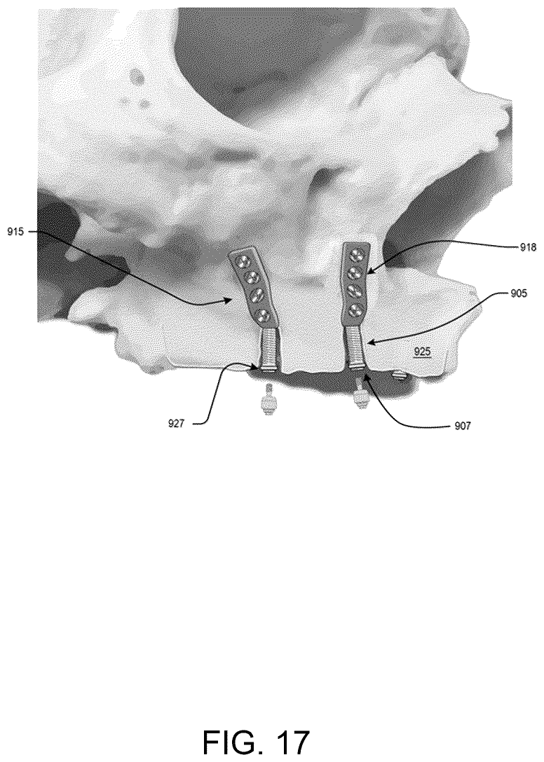

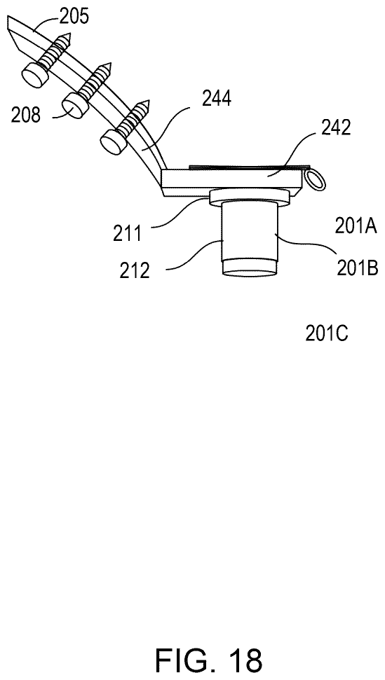

FIG. 13 shows a schematic of a drill guide attached to a tooth. FIG. 14 shows the drill guide limiting depth and angle of attack. Custom 3D printed acrylic drill guides can be attached to the teeth and/or contours of the dental arch and used to guide drill depth and alignment. A pilot guide tip of wider drills can help keep the holes drilled concentrically.

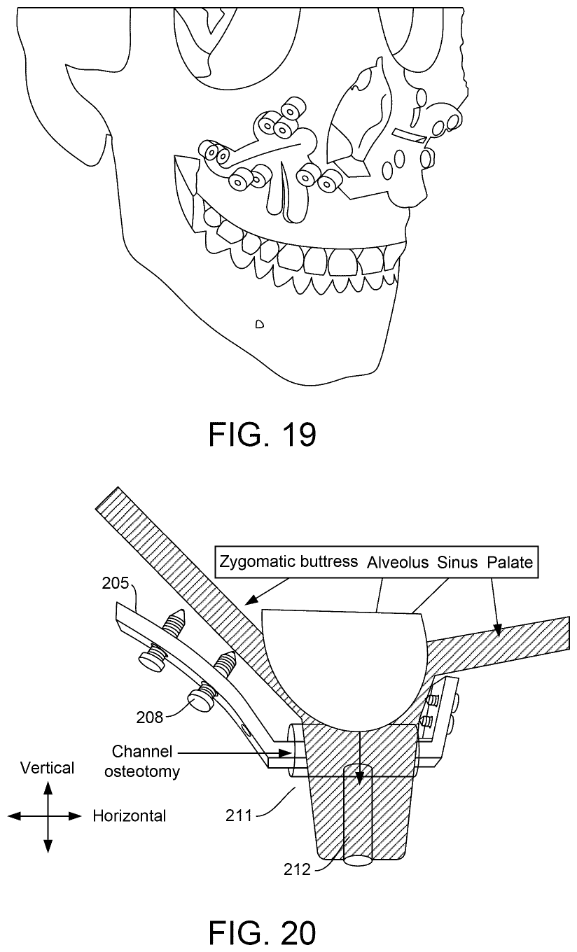

FIG. 15 shows a schematic of a CT image, according to an embodiment of the present disclosure. In an embodiment, a drill guide can be based on CT scans to guide drilling and avoid vital structures, such as tooth roots, nerves, vessels, nasal structures, orbits, and sinuses. Complicating this procedure is the non-homogenous nature of dentoalveolar bone density which can deflect drills. Additionally, since osteotomies are smaller in diameter than the dental implant to be inserted, which is a requirement to obtain primary stability of the dental implant, non-homogenous dense areas around the walls of an osteotomy can deflect dental implants into a poor clinical position as the implant is screwed into place, confounding even the best efforts to accurately position a dental implant.

Referring back to FIGS. 12 and 13, some dental implant (acrylic) guides can add vertical bulk of material between the jaws (interocclusal space), which complicates placement of drills and handpieces orthogonal to the occlusal plane to insert into the metal tubes of the guides, as shown. For example, the handpiece head and drills can have a vertical dimension of 25 mm. This can be clinically problematic when drilling posterior osteotomies orthogonal to the occlusal plane because the interocclusal spaces is often less than 25 mm. Certain jaw disorders can further limit interocclusal spaces, such as acquired trismus, joint ankylosis, and various deformities.

Upon adequate osseointegration of the (titanium) dental implant through a process of bone maturation and physiological remodeling, osseointegration (secondary stability) can be maintained unless disturbed by excessive and prolonged occlusal forces and loads. When osteointegration fails, the results are catastrophic loss of dental implants and prostheses. The resultant bone defects leave patients with few options to restore their dentition with fixed prostheses. Often bone grafting and escalating levels of invasive surgery leads to more failures because the biology of bone and investing soft tissue becomes scarred and fibrotic. Many patients with failed or failing conventional dental implants experience a path of escalating surgical procedures with poor or limited results.

As such, a treatment process and apparatus to place dental implants definitively and accurately is desired. The goals of the process can include obtaining primary and secondary stability as a function of correctly sized and positioned osteotomies, adequate (titanium) implant surfaces, and Bone-in-Contact of dental implants, and all surgery performed with minimal disruption to the investing biological tissues.

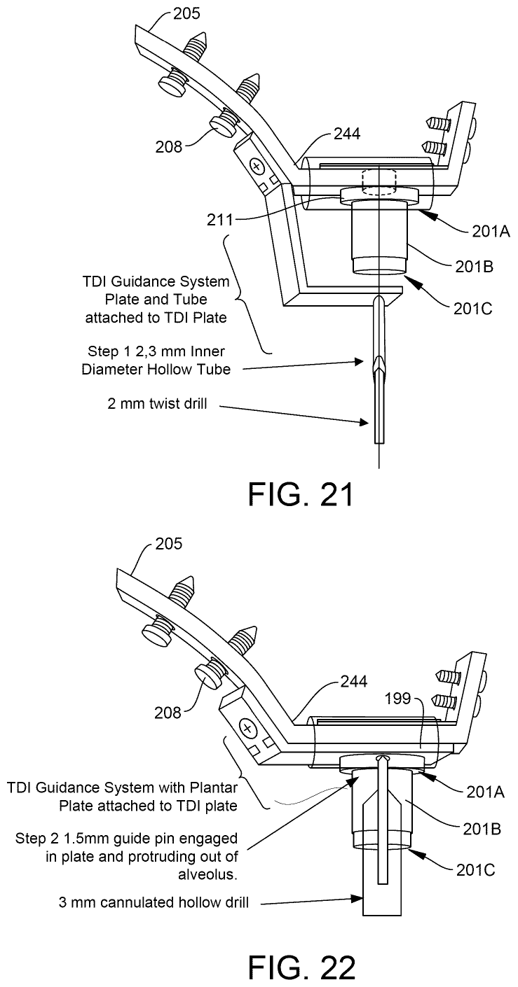

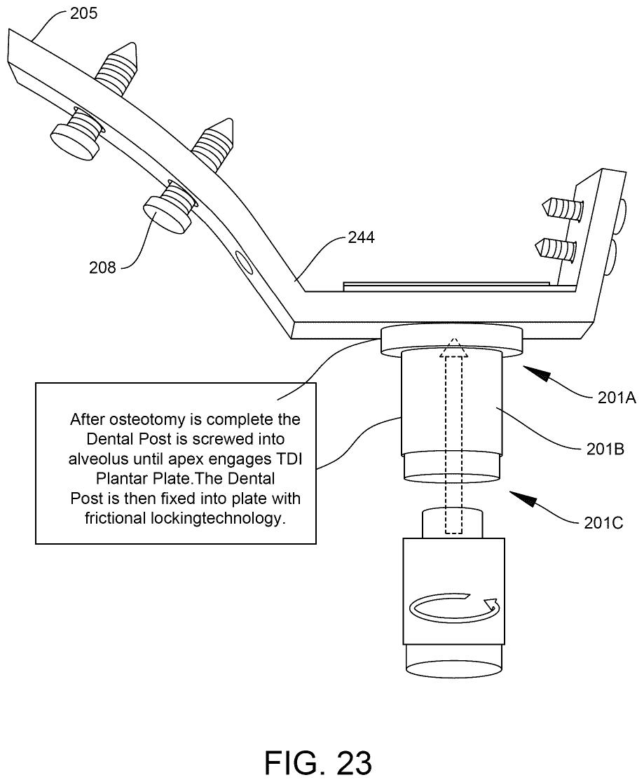

To this end, FIG. 16 is a schematic of the TDI system, according to an embodiment of the present disclosure. FIG. 17 is a schematic of the TDI system engaged in a skull, according to an embodiment of the present disclosure. In an embodiment, the TDI system can include a dental post (such as the dental post 408) attached to a bone plate (such as the bone plate 400), the bone plate including a plantar portion embedded into the base of the dentoalveolus to support the dental post and a contoured portion fixated to adjacent cortical bones with locking mini bone screws. In an embodiment, the bone plate can be molded, stamped, 3D printed, CNC machined, etc. A material of the bone plate can be a metal, a polymer, etc. Essentially, the TDI system provides remote primary stability of dental post(s) through attachment to an embedded bone plate(s) fixated remotely to adjacent cortical bone structures. The system is particularly useful in cases of inadequate dentoalveolar bone to support a dental implant.

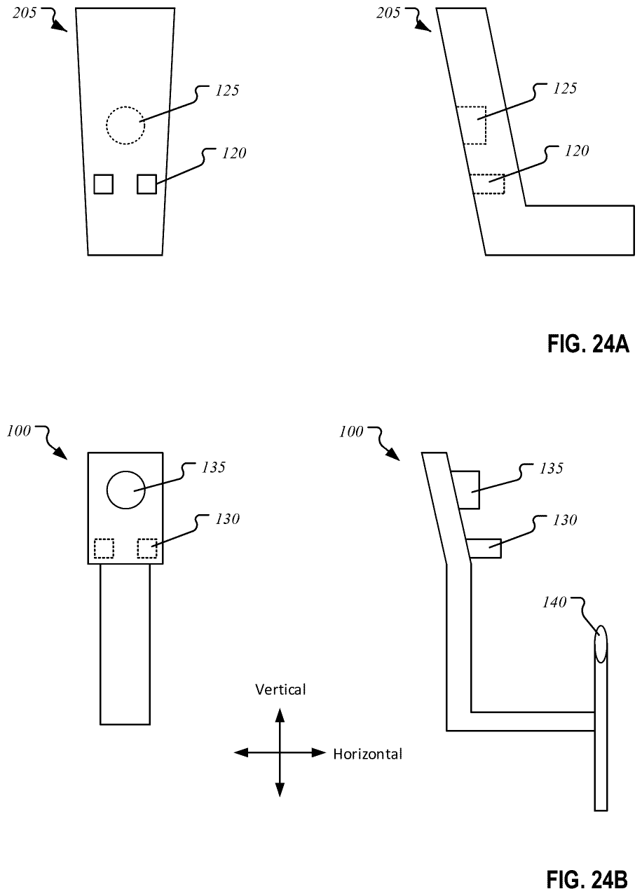

FIG. 18 shows a schematic of the TDI system including a dental post with a threaded apex engaged therein, according to an embodiment of the present disclosure. In an embodiment, the TDI system can include a TDI dental post 212 with a threaded apex to frictionally lock into a corresponding threaded aperture of a previously positioned and affixed TDI bone plate 205, in situ. In an embodiment, the TDI bone plate 205 can include two portions: a first portion 242 can be a planar portion 242 and a second portion 244 can be a contoured portion 244. The contoured portion 244 can be contoured with respect to a selected region of the facial skeleton determined to be of sufficient bone quality for fixation. In an embodiment, the bone plate 205 may be fabricated via direct metal laser sintering. In an embodiment, the bone plate 205 can be a non-metallic material such as zirconia, ceramic, fiber-reinforced resins, and carbon fiber, fiberglass, or a metallic material such as titanium, stainless steel, titanium alloy, and gold alloy. Other materials, as appropriate, can also be used.

In an embodiment, a thickness of the planar portion 242 of the bone plate 205 can be between 1 mm and 2 mm and a length of the planar portion 242 of the bone plate 205 can be between 6 mm and 10 mm. For example, the thickness of the planar portion 242 of the bone plate 205 can be 1.5 mm and a length of the planar portion 242 of the bone plate 205 can be 8 mm.

In an example, the thickness of the bone plate 205 can range between 1.00 mm and 3.00 mm, and preferably between 1.25 mm and 2.00 mm. The length of the bone plate 205, therefore, is determined according to locally sufficient cortical bone.

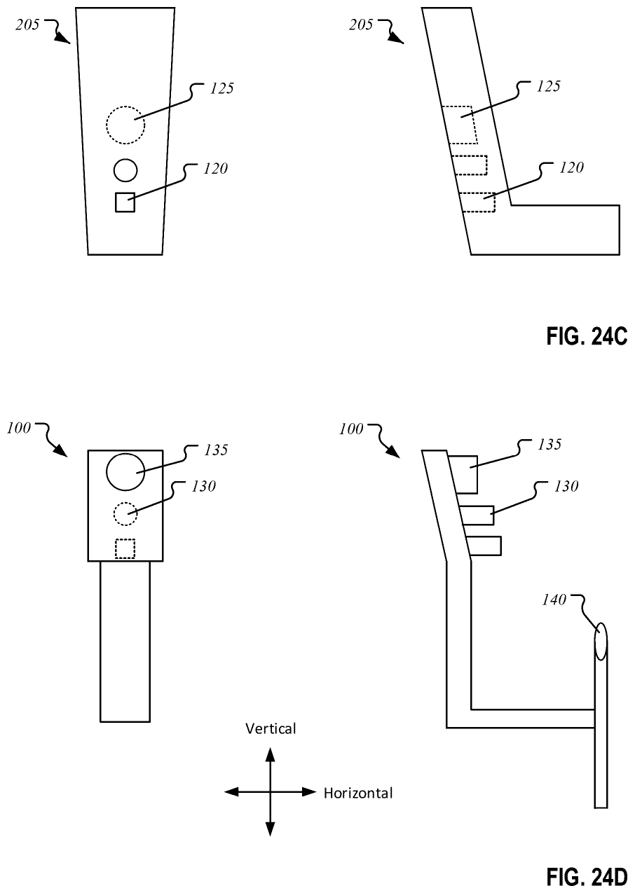

FIG. 19 shows a schematic of templates for drilling screw holes, according to an embodiment of the present disclosure. In an embodiment, the TDI bone plate(s) 205 can be positioned with templates to drill screw holes and channel osteotomies which correspond to TDI bone plate 205 screw apertures.

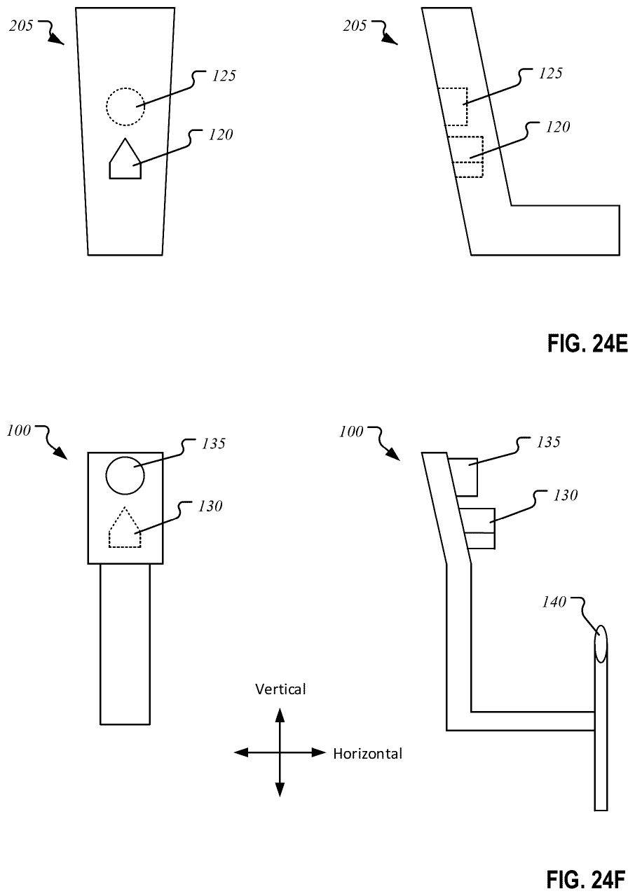

FIG. 20 shows a schematic of the TDI system engaged after a channel osteotomy, according to an embodiment of the present disclosure. In an embodiment, to support delivery of the TDI system, a transalveolar channel osteotomy from buccal to lingual (horizontally oriented) at the base of the dentoalveolus can be performed to place and fixate a custom TDI bone plate, such as the TDI bone plate 205, followed by another osteotomy from the dentoalveolar crest (vertically oriented) to end in the channel osteotomy occupied by the fixated TDI bone plate 205.

In an embodiment, the TDI bone plate 205 can include an aperture or opening along a portion of the TDI bone plate 205, such as along the planar portion 242 of the TDI bone plate 205. The aperture can be configured to receive an object inserted therein and reversibly secure the object. For example, the aperture can include threads for receiving an object with complementary threading. For example, the aperture can be configured to receive a reversibly snap-fit or push-fit object inserted therein. The aperture can be designed and fabricated to secure the object arranged therein at a desired angle and orientation. For example, an elongated guide rod can be inserted therein at a desired angle and there can be little to no movement or deflection of the elongated guide rod once secured.

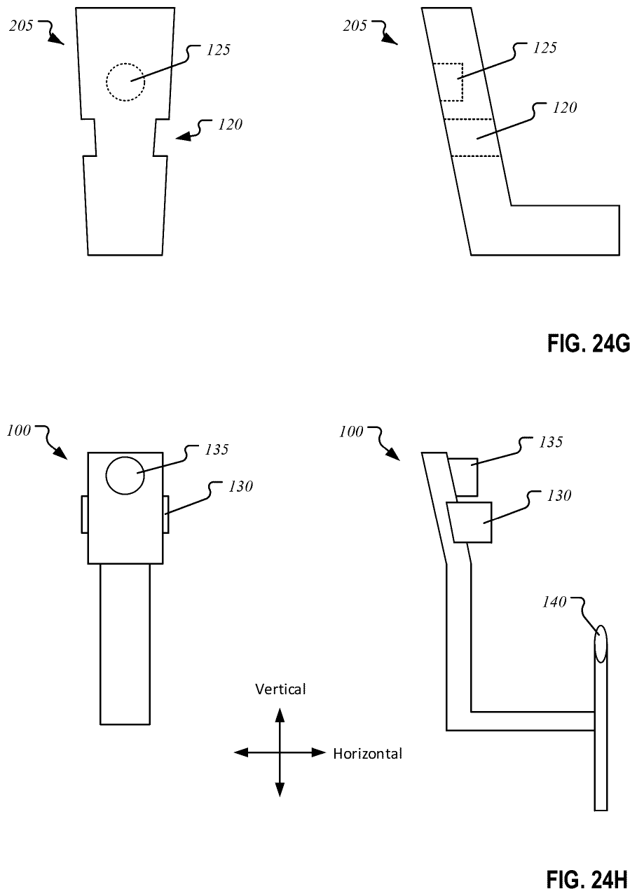

FIG. 21 shows a schematic of the TDI system engaged after a vertical osteotomy, according to an embodiment of the present disclosure. In an embodiment, when the vertical osteotomy is precisely drilled, the dental implant (such as the dental post 212) can be screwed through the crest with the post threaded apex aligned directly over the corresponding threaded aperture of the embedded portion of the TDI bone plate 205 (such as the planar portion 242). Additional torquing of the dental implant can then frictionally lock the dental post to the TDI bone plate 205. The drill guidance apparatus 100 can therefore be used to provide the necessary precision of the osteotomies. Further, the drill guidance apparatus 100 can be designed for placement of the drill guidance apparatus 100 together with the drill and handpiece as a unit, from a lateral approach, not interocclusally, and secured on features of the TDI bone plate 205 (or 400) for accurate drilling.

To this end, FIGS. 21 to 24J show schematics of the drill guidance apparatus 100, according to an embodiment of the present disclosure. In an embodiment, as briefly described before, the drill guidance apparatus 100 can be secured to features of the fixated TDI bone plate 205 to the dental arch through a lateral approach, to provide precise drilling of osteotomies to support the assembly of the TDI system, in situ. The drill guidance apparatus 100 can include a laterally aligned bracket system (metal or polymer) that is configured to slide into engineered features of the TDI bone plate 205 and optionally secured to the TDI bone plate 205 with a security feature. Projecting laterally from the bracket can be an extension arm or portion (metal or polymer) configured to arrange a guidance tube (such as guidance tube 140 described herein) thereon with an inner diameter of, for example, 0.5 to 5 mm, or 2 to 3 mm, or 2.3 mm, and a length of, for example, 2 to 20 mm, or 4 to 15 mm, or 5 to 10 mm. The guidance tube can be arranged over a predetermined point on the crest of the dentoalveolus and aligned with the threaded aperture of the underlying TDI bone plate 205. In an embodiment, the drill guidance apparatus 100 can be molded, stamped, 3D printed, CNC machined, etc. A material of the drill guidance apparatus 100 can be a metal, a polymer, etc.

Additionally or alternatively, another extension from the bracket can be an extension plate 199 (metal or polymer) arranged directly over the embedded plantar (planar) portion 242 of the TDI bone plate 205 and covering the threaded aperture hole.

To this end, FIG. 24I and FIG. 24J show schematics of the extension plate 199, according to an embodiment of the present disclosure. In an embodiment, an aperture 180 (threaded or non-threaded) in the extension plate 199, such as a 1.25 mm aperture 180, can align precisely with a center of the underlying aperture of the TDI bone plate 205. In an embodiment, as shown in FIG. 24I, the extension arm can be modular and detachable from the engagement surface and the extension plate 199. In an embodiment, as shown in FIG. 24J, the extension plate 199 is formed as part of the engagement plate and therefore two of the drill guidance apparatus 100 are used: a first apparatus 100y with the extension plate attached to the contoured portion and a second apparatus 100z with the extension arm attached to the contoured portion, wherein the first apparatus 100y is attached to the TDI bone plate 205 first and the second apparatus 100z is attached to the first apparatus 100y, then removed after the initial hole is drilled. Of course, similar alignment sleeves 120 and alignment pins 130 can be included in the first apparatus 100y and the second apparatus 100z for alignment with one another.

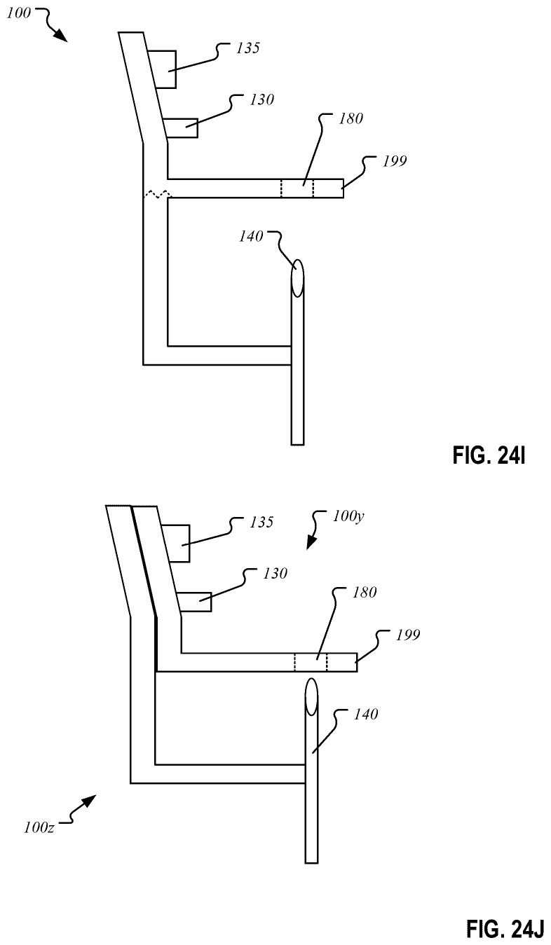

In an embodiment, the drill guidance apparatus 100, with the drill in the guidance tube and drill engaged into the handpiece, can slide into TDI bone plate 205, laterally, and secured with, for example, a setscrew. A 2 mm diameter drill of appropriate length can then be used to drill the initial hole through the crest of the dentoalveolus using the 2.3 mm inner diameter tube for guidance until the drill encounters the underlying extension plate 199 of the drill guidance apparatus 100. As shown in FIG. 22, the guidance tube 140 (and, optionally, the extension arm) of the drill guidance apparatus 100 can be removed and a threaded guide rod or pin (e.g., 1.5 mm diameter, 15 mm in length) can be arranged through the osteotomy site and secured in the aperture 180 of the extension plate 199 of the drill guidance apparatus 100. In an embodiment, a 3.5 mm cannulated twist drill can be placed over the guide rod and the 2 mm wide osteotomy can be concentrically widened to 3.5 mm in diameter. Wider diameter cannulated drills and taps can be used to complete the osteotomy.

As shown in FIG. 23, the guide rod and the drill guidance apparatus 100 can be removed and the TDI dental post 212 can be screwed through the (vertical) osteotomy site with the threaded apex of the dental post 212 aligned to engage the threaded aperture of the TDI plantar (planar) portion 205 and tightened to fasten the dental post 212 to the planar portion 205 with adequate frictional forces. Bone graft particles and membranes can be used to fill in gaps of the osteotomy sites and incisions closed before the dental prosthesis is attached to the TDI dental implant platform(s) (the dental post 212) for immediate function.

Returning to the Figures, FIGS. 24A to 24J show schematics of various fastening and alignment features for the bone plate 205 and complementary features on the drill guidance apparatus 100, according to an embodiment of the present disclosure. In an embodiment, in FIG. 24A, the bone plate 205 can include an alignment sleeve 120 and a security feature 125. As shown, the alignment sleeve 120 can be an opening in the bone plate 205 along contoured portion 244. The alignment sleeve 120 can extend a predetermined depth into the bone plate 205 or extend entirely through the bone plate 205. The alignment sleeve 120 can have a cross-sectional shape, such as a circle, triangle, square (as shown), pentagon, any n-sided shape, or a unique shape. The bone plate 205 can include one or more of the alignment sleeve 120. For example, as shown in FIG. 24A, the bone plate 205 can include two of the alignment sleeves 120. As shown in FIG. 24E, the bone plate 205 can include only one alignment sleeve 120. Additionally or alternatively, the bone plate 205 can include more than two of the alignment sleeves 120, such as three, or four, or any number n. The alignment sleeve 120 can be configured to help align the drill guidance apparatus 100 upon securing the drill guidance apparatus 100 to the bone plate 205. The number, design, and arrangement of the alignment sleeve 120 can also be configured to help in aligning the drill guidance apparatus 100.

In an embodiment, the security feature 125 can be configured to help secure the drill guidance apparatus 100 to the bone plate 205. The security feature 125 can be, for example, threads for receiving a screw attached to the drill guidance apparatus 100 to reversibly fasten the drill guidance apparatus 100 to the bone plate 205. The security feature 125 can be, for example, a magnet for attracting a complementary magnet attached to the drill guidance apparatus 100 to reversibly fasten the drill guidance apparatus 100 to the bone plate 205.

To this end, FIG. 24B shows a schematic of the drill guidance apparatus 100, according to an embodiment of the present disclosure. In an embodiment, the drill guidance apparatus 100 includes an alignment pin 130 and an attachment feature 135. In an embodiment, the drill guidance apparatus 100 includes an engagement surface configured to engage with the contoured portion 244 of the bone plate 205, and the alignment pin 130 and the attachment feature 135 are disposed on or formed as part of the engagement surface. The alignment pin 130 can be a protrusion extending from the engagement surface, and the alignment pin 130 can have a cross-sectional shape. For example, the cross-sectional shape of the alignment pin 130 can be circular, triangular, square (as shown), pentagonal, n-sided, a unique shape, or complementary to the cross-sectional shape of the alignment sleeve 120. That is, the alignment sleeve 120 can be configured to receive the alignment pin 130. Furthermore, the alignment pin 130 can be arranged on the engagement surface at a position relative to the attachment feature 135 that is the same as the alignment sleeve 120 arranged relative to the security feature 125. That is to say, an offset of the attachment feature 135 from the alignment pin 130 is a same offset as an offset of the security feature 125 from the alignment sleeve 120.

Additionally or alternatively, the drill guidance apparatus 100 can include more than two of the alignment pins 130, such as three, or four, or any number n. As shown in FIG. 24B, the drill guidance apparatus 100 includes two of the alignment pins 130 aligned horizontally. The additional alignment pin 130 can help further ensure accurate alignment of the drill guidance apparatus 100 relative to the bone plate 205 in order to ensure a guidance tube 140 is accurately aligned to facilitate drilling at a desired angle.

In an embodiment, the attachment feature 135 can be configured to secure the drill guidance apparatus 100 to the bone plate 205. For example, as previously described, the attachment feature 135 can be a screw threaded through the engagement surface. Upon mating the drill guidance apparatus 100 to the bone plate 205, the screw can be threaded through the security feature 125 of the bone plate 205, such as complementary threads. For example, as previously described, the attachment feature 135 can be a magnet configured to attract the complementary magnet (the security feature 125) on the bone plate 205.

In an embodiment, when the security feature 125 on the bone plate 205 is a magnet, the magnet need not be permanently attached to or formed as part of the bone plate 205. For example, the bone plate 205 can include an opening for inserting and reversibly attaching the magnet to the bone plate 205 for the purposes of aligning and securing the drill guidance apparatus 100. For example, the magnet (the security feature 125) can be screwed into threads of the opening, or press fit into the opening, or secured in the opening using an adhesive, etc. Upon completion of drilling for implanting the implant, the drill guidance apparatus 100 can be removed from the bone plate 205, the magnet can be removed from the opening, and the opening can optionally be filled, covered, or otherwise closed.

FIG. 24C shows a schematic of the alignment sleeves 120 on the bone plate 205 with keyed shapes, according to an embodiment of the present disclosure. In an embodiment, the bone plate 205 includes two of the alignment sleeves 120, but the cross-sectional shapes of the alignment sleeves 120 can be different. As shown, the cross-sectional shape of one of the alignment sleeves 120 can be circular while the cross-sectional shape of one of the alignment sleeves 120 can be square. Additionally or alternatively, the two alignment sleeves 120 can be arranged vertically instead of horizontally. The different shapes can ensure the drill guidance apparatus 100 is engaged with the bone plate 205 in the correct orientation.

To this end, FIG. 24D shows a schematic of the alignment pins 130 on the drill guidance apparatus 100 with keyed shapes, according to an embodiment of the present disclosure. In an embodiment, the drill guidance apparatus 100 includes two of the alignment pins 130, but the cross-sectional shapes of the alignment pins 130 can be different (and complementary to the alignment pins 120 of FIG. 24C). As shown, the cross-sectional shape of one of the alignment pins 130 can be circular while the cross-sectional shape of one of the alignment pins 130 can be square. The two alignment pins 130 can be arranged vertically to match the arrangement of the alignment pins 120. Upon engaging the drill guidance apparatus 100 with the bone plate 205, the keyed complementary shapes can ensure the drill guidance apparatus 100 is not upside-down or otherwise aligned incorrectly. In such an incorrect arrangement, the alignment pin 130 with the circular cross-sectional shape can be designed to not fit into the alignment sleeve 120 with the square cross-sectional shape and the alignment pin 130 with the square cross-sectional shape can be designed to not fit into the alignment sleeve 120 with the circular cross-sectional shape. Furthermore, in the incorrect arrangement, the attachment feature 135 and the security feature 125 can be misaligned and therefore the security of the drill guidance apparatus 100 to the bone plate 205 can be poor.

FIG. 24E shows a schematic of the bone plate 205 with one of the alignment sleeve 120, according to an embodiment of the present disclosure. In an embodiment, the cross-sectional shape of the alignment sleeve 120 can be unique and not have rotational symmetry, and therefore one of the alignment sleeve 120 can be sufficient for aligning the drill guidance apparatus 100 to the bone plate 205.

To this end, FIG. 24F shows a schematic of the drill guidance apparatus 100 with the complementary alignment pin 130, according to an embodiment of the present disclosure. In an embodiment, the cross-sectional shape of the alignment pin 130 can be unique and not have rotational symmetry. Again, this cross-sectional shape of the alignment pin 130 can be designed to be complementary to the alignment sleeve 120. Therefore, the alignment pin 130 can only be inserted into the alignment sleeve 120 in one orientation. As shown, the orientation can be such that a pointed end of the cross-sectional shape is facing upwards or vertically. Advantageously, a single alignment pin 130 and a single alignment sleeve 120 can be easier to align and insert while also reducing issues arising from manufacturing tolerances when more than one alignment pin 130 and more than one alignment sleeve 120 are used.

FIG. 24G shows a schematic of the bone plate 205 with the alignment sleeve 120 formed along an edge of the bone plate 205, according to an embodiment of the present disclosure. In an embodiment, the alignment sleeve 120 can be an indent or cut-out along an edge or side of the contoured portion 244 of the bone plate 205. As shown, the bone plate 205 includes two of the alignment sleeves 120 formed as two indents. Additionally or alternatively, only one of the indents can be formed for the alignment sleeve 120. The alignment sleeve 120 as an indent can be configured to receive the alignment pin 130.

To this end, FIG. 24H shows a schematic of the drill guidance apparatus 100 with the alignment pin 130 formed along an edge of the engagement surface, according to an embodiment of the present disclosure. In an embodiment, the alignment pin 130 disposed along the edge of the engagement surface takes the form of an arm configured to slide into the alignment sleeve 120. Here, the peripheral arrangement of the alignment sleeve 120 eliminates the formation of a pocket in the bone plate 205 for the alignment sleeve 120. Furthermore, it can be easier for a technician to visually align the drill guidance apparatus 100 to the bone plate 205 when the alignment sleeve 120 is disposed along the edge of the bone plate 205.

In an embodiment, the alignment sleeve 120 can be formed at predetermined locations in the bone plate 205 to adjust an angle and position of the guidance tube 140 and therefore the angle and position of the drill bit eventually inserted therein.

In an embodiment, the drill guidance apparatus 100 and the bone plate 205 need not include the attachment feature 135 and the security feature 125, and the drill guidance apparatus 100 and the bone plate 205 can be engaged and held in place via friction forces or via force applied by the technician.

In an embodiment, the drill guidance apparatus 100 need not include the attachment feature 135, and the drill guidance apparatus 100 and the bone plate 205 can be engaged and held in place via just the security feature 125 when the security feature 125 is an adhesive. The adhesive can be tailored for dental applications. For example, the security feature 125 is an adhesive applied into an opening in the bone plate 205, and after removal of the drill guidance apparatus 100, the adhesive can be removed or left as-is while being an inert material that does not react with or negatively affect the organic material that eventually forms over the bone plate 205.

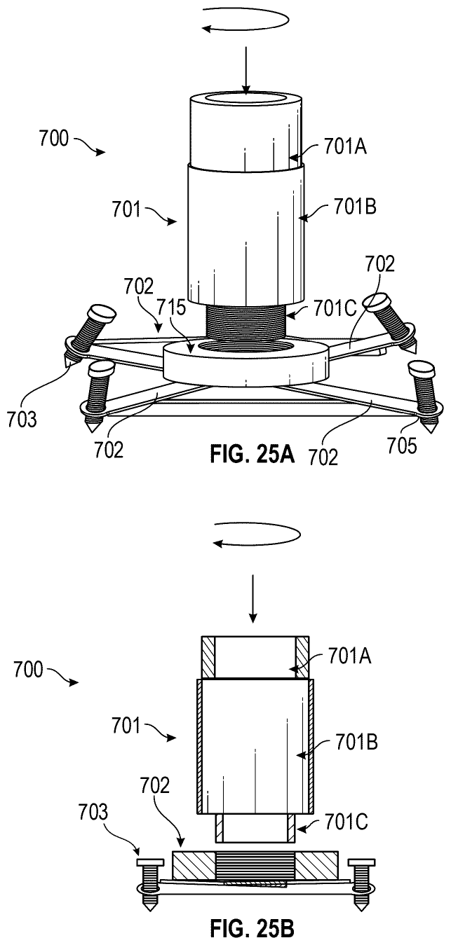

FIGS. 25A and 25B show schematics of a custom lower molar TDI (LM-TDI) 700, according to an embodiment of the present disclosure. In an embodiment, the upper molar TDI structure (for securing the TDI bone plate 205) and the LM-TDI structure can be similar. Therefore, FIG. 25A and FIG. 25B can illustrate that the LM-TDI 700 includes the dental post 701, the cylindrical plate 715, locking mini screws 703, support lattices 702, and apertures 705. The LM-TDI 700 described at least partially below is described in U.S. patent application Ser. No. 17/553,085, filed Dec. 16, 2021, the entire content of which is incorporated herein by reference in its entirety for all purposes.

In FIG. 25A, a perspective view of a dental post 701 secured to LM-TDI cylindrical plate 715 in situ with frictional coupling is shown. In FIG. 25B, a side view of the dental post 701 secured to LM-TDI cylindrical plate 715 in situ with frictional coupling is shown.

In an embodiment, the support lattices 702 on the LM-TDI 700 can extend from buccal and lingual ends of the cylindrical plate 715 in FIG. 25A. In an example, the thickness of the bone plate of the LM can range between 1.00 mm and 3.00 mm, and preferably between 1.25 mm and 2.00 mm. The length of the support lattices of the LM-TDI 700 can be determined according to locally sufficient cortical bone.

In an embodiment, similar to the UM-TDI bone plate 205, the cylindrical plate 715 of the LM-TDI 700 can also have an opening in a central region thereof. The opening of the cylindrical plate 715 can be configured to receive the dental post 701. The diameter of the cylindrical plate 715 can be between 5 mm and 8 mm, and preferably 6 mm. The diameter of the opening of the cylindrical plate 715 can be between 3 mm and 6 mm, and preferably 4 mm.

In an embodiment, the dental post 701 may include a post base 701A, a post body 701B, and a post apex 701C. The dental post 701 may be configured to receive an abutment. The post body 701B can be the body portion of the dental post 701.

In an embodiment, the diameter of the post base 701A of the dental post 701 can range between 3 mm and 6 mm. For example, the diameter of the post base 701A of the dental post 701 can be 4.5 mm. The height of the post base 701A can be between 2 mm and 3 mm.

In an embodiment, the diameter of the post body 701B of the dental post 701 can range between 4 mm and 7 mm. For example, the diameter of the post body 701B of the dental post 701 can be 5.5 mm. The height of the post body 701B can be between 6 mm and 10 mm.

In an embodiment, the diameter of the post apex 701C of the dental post 701 can range between 3.5 mm and 4 mm. For example, the diameter of the post apex 701C of the dental post 701 can be 4 mm. The height of the post apex 701C can be between 2 mm and 3 mm.

In an embodiment, the diameter of the post apex 701C of the dental post 701 can be the same as the opening of the cylindrical plate 715. For example, the diameter of the post apex 701C of the dental post 701 can be 4 mm and the opening of the cylindrical plate 715 can be 4 mm.

In an embodiment, locking mini screws 703 can be used to mount the LM-TDI 700 to the buccal and lingual cortices of the patient. In an embodiment, the number of the locking mini screws 703 can be, but not limited to, four, as illustrated in FIG. 25A. The length of the locking mini screws 703 can be between 4 mm and 8 mm. For example, the length of the locking mini screws 703 can be 5 mm. The diameter of the locking mini screws 703 can be between 1 mm and 2 mm.

In an embodiment, support lattices 702 can be coupled to the cylindrical plate 715. The support lattices 702 can extend from the buccal and lingual ends the cylindrical plate 715. The support lattices 702 can include apertures 705 for fixation. The support lattices 702 can be fixed to the facial skeleton by the locking mini screws 703 inserted into cortices of the facial skeleton through the apertures 705. In some embodiments, a bone graft alveolus can extend around the dental post 701, the cylindrical plate 211, and the support lattices 702.

In an embodiment, the support lattices 702 can have a length between 1 mm and 3 mm. The support lattices 702 can have a width between 1 mm and 2 mm. The number of the support lattices 702 used in the LM-TDI can be dependent on the number of the locking mini screws 703 and the number of the apertures 703. For example, four support lattices 702 are used to support four apertures 703, and four locking mini screws 703 are used to fix the dental post 701 through the four apertures 703.

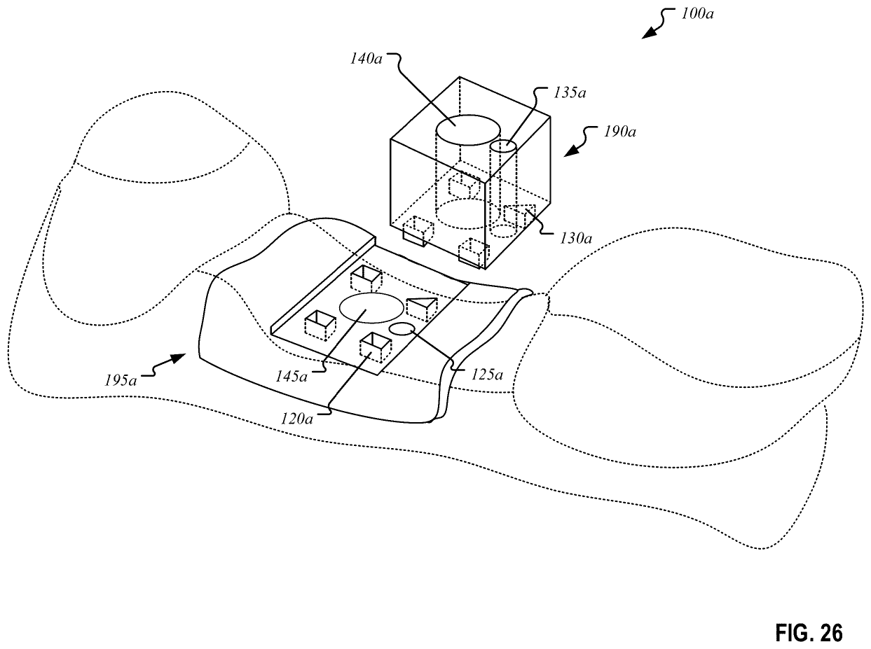

FIG. 26 shows a schematic of a drill guidance apparatus 100a, according to an embodiment of the present disclosure. In an embodiment, the drill guidance apparatus 100a can include a guide body 190a and a guide base 195a. Similar to the drill guidance apparatus 100, the guide body 190a can include an alignment pin 130a and an attachment feature 135a. Similar to the bone plate 205, the guide base 195a can include an alignment sleeve 120a and a security feature 125a. The guide body 190a and the guide base 195a can be configured to couple upon engagement of the alignment pin 130a in the alignment sleeve 120a. The attachment feature 135a can be configured to secure the guide body 190a to the guide base 195a via the security feature 125a. The guide base 195a can be designed or molded to contour to the dentoalveolar bone of the lower molar area in which the LM-TDI 700 is to be implanted, and include an aperture 145a. The guide body 190a can include a guidance tube 140a through which a drill can be inserted, wherein the guidance tube 140a can be aligned to a center of the aperture 145a of the guide base 195a when the guide body 190a is coupled to the guide base 195a. Notably, the drill can be inserted into the guide body 190a prior to coupling the guide body 190a to the guide base 195a. This can prevent any issues from the previously described complications due to placement of drills and handpieces orthogonal to the occlusal plane to insert into the metal tubes of the guides in FIG. 13.

In an embodiment, multiple of the guide bases 195a can be generated having the aperture 145a at various positions and with varying diameters. For example, when the LM-TDI 700 includes four of the locking mini screws 703 and four of the apertures 705, four of the guide bases 195a can be generated based on the contour of the LM cortices and each of the four guide bases 195a can have the aperture 145a at various locations corresponding to a position where the four locking mini screws 703 will attach to the LM buccal and lingual cortices. The diameter of the aperture 145a can also be narrower for the locking mini screws 703. The guide body 190a can then be used to arrange the drill at the desired angle to drill into the LM buccal and lingual cortices to form (pilot) holes for the locking mini screws 703. Additionally or alternatively, a single guide base 195a can include all of the needed apertures 145a with the alignment sleeves 120a arranged relative to the various apertures 145a at the corresponding positions on the guide base 195a. This can prevent any misalignment of the guide base 195a when swapping in another guide base 195a for a different position locking mini screw 703.

Additionally or alternatively, while the dental post 701 can be fastened solely to the LM-TDI 700, in an embodiment, the threaded post apex 701C can be designed to pass through the frictional coupling and into an opening formed in the dentoalveolar bone. Thus, the guide base 195a and the guide body 190a can be configured to help form an opening with a desired depth, diameter, and angle. A dental implant can be immediately implanted therein, or the LM-TDI 700 can be installed over the formed opening, fixated to the cortices using the locking mini screws 703, and have the dental post 701 secured through the friction coupling and into the formed opening. The formed opening can optionally include a threaded receiving implant already implanted in the dentoalveolar bone. Of course, the drill guidance apparatus 100a can be used as well to form the opening for the threaded receiving implant. It may be appreciated that the aforementioned steps need not occur in the recited order, and that the dental post 701 can be secured through the friction coupling and into the formed opening before fastening via the locking mini screws 703.

The drill guidance apparatus 100 and the drill guidance apparatus 100a can provide apparatuses and methods to perform precision dental implant osteotomies through a lateral approach to support the placement and assembly of the TDI system, in situ. The TDI dental post, when coupled with a TDI bone plate (e.g., TDI bone plates 205, 400), addresses reconstruction of inadequate dentoalveolar bone structures by providing primary stability to dental posts by their attachment to bone plates fixated to adjacent cortical bone structures of the face. The primary stability achieved by the TDI system allows for osseointegration of dental posts to occur in cases when the dentoalveolar bone is inadequate to stabilize a conventional dental implant.

Additionally, the method of osteotomies can be performed minimally invasively to preserve the biology of the dentoalveolus for favorable osseointegration of the dental posts. Importantly, occlusal forces on osseointegrated dental posts are resisted not only by the bone formation to the dental implant, but the forces are transmitted through the attached TDI bone plate and ultimately resisted by a plurality of mini bone screws used to fixate the TDI plates to adjacent cortical facial bones. Essentially, TDI technology load-shares occlusal forces to cortical facial bones and increases the Bone-in-Contact with titanium surface by the addition of mini bone screws.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A dental implant guidance apparatus, comprising:
a fixation plate including:
a contoured portion attached to a planar portion,
an alignment sleeve disposed on the contoured portion, the alignment sleeve including an opening extending at least partially into the contoured portion of the fixation plate,
a security feature disposed on the contoured portion, and
an aperture disposed on the planar portion; and
a drill guidance apparatus including:
an engagement surface attached to an extension arm, the engagement surface configured to abut the contoured portion of the fixation plate,
an alignment pin disposed on the engagement portion and configured to be inserted into the alignment sleeve, the alignment pin protruding from the engagement surface,
an attachment feature disposed on the engagement portion, the attachment feature configured to couple with the security feature, and
a guidance tube disposed on the extension arm, the guidance tube configured to receive an object therein through a length of the guidance tube.

2. The apparatus of claim 1, wherein the alignment sleeve includes a cross-sectional shape and the alignment pin includes a cross-sectional shape complementary to the cross-sectional shape of the alignment sleeve.

3. The apparatus of claim 2, wherein the cross-sectional shape of the alignment sleeve and the cross-sectional shape of the alignment pin is a shape not having rotational symmetry.

4. The apparatus of claim 1, wherein an offset of the alignment sleeve from the security feature is a same offset as an offset of the alignment pin from the attachment feature.

5. The apparatus of claim 1, wherein the security feature is a threaded opening and the attachment feature is a screw configured to thread into the threaded opening.

6. The apparatus of claim 1, wherein the security feature is a first magnet disposed in an opening in the contoured portion and the attachment feature is a complementary second magnet configured to attract the first magnet.

7. The apparatus of claim 1, wherein the fixation plate includes at least two of the alignment sleeve and the drill guidance apparatus includes at least two of the alignment pin.

8. The apparatus of claim 7, wherein
the cross-sectional shape of a first alignment sleeve is different than the cross-sectional shape of a second alignment sleeve, and
the cross-sectional shape of a first alignment pin is different than the cross-sectional shape of a second alignment pin, the cross-sectional shape of the first alignment sleeve being complementary to the cross-sectional shape of the first alignment pin, the cross-sectional shape of the second alignment sleeve being complementary to the cross-sectional shape of the second alignment pin.

9. The apparatus of claim 7, wherein
a first alignment sleeve and a second alignment sleeve are disposed on the contoured portion according to a predetermined arrangement, and
a first alignment pin and a second alignment pin are disposed on the engagement surface according to a predetermined arrangement complementary to the predetermined arrangement of the first alignment sleeve and the second alignment sleeve.

10. The apparatus of claim 1, wherein the alignment sleeve is disposed along a central portion of the contoured portion.

11. The apparatus of claim 10, wherein the alignment pin is disposed along a central portion of the engagement surface.

12. The apparatus of claim 1, wherein the alignment sleeve is disposed along an edge of the contoured portion.

13. The apparatus of claim 12, wherein the alignment pin is disposed along an edge of the engagement surface.

14. The apparatus of claim 1, wherein the drill guidance apparatus further includes an extension plate attached to the engagement surface, the extension plate including an aperture, the drill guidance tube being aligned with the aperture of the extension plate.

15. The apparatus of claim 14, wherein the extension plate is configured to insert into a channel osteotomy upon coupling the drill guidance apparatus to the fixation plate.

16. The apparatus of claim 14, wherein the extension arm is detachable from the engagement surface.

17. The apparatus of claim 16, wherein the extension arm is detached from the engagement surface upon completion of formation of a first opening.

18. The apparatus of claim 1, further comprising an auxiliary drill guidance apparatus including an engagement surface attached to an extension plate, the engagement surface configured to abut the contoured portion of the fixation plate, the extension plate including an aperture, the drill guidance tube of the drill guidance apparatus configured to align with the aperture upon coupling the drill guidance apparatus to the auxiliary drill guidance apparatus.

19. The apparatus of claim 1, wherein the guidance tube is configured to receive a drill bit inserted therein prior to the drill guidance apparatus coupling to the fixation plate.

20. A method of performing an osteotomy, comprising:
attaching a fixation plate to skeletal bone, the fixation plate being disposed at least partially in dentoalveolar bone;
inserting a drill bit through a guidance tube of a drill guidance apparatus;
coupling the drill guidance apparatus to the fixation plate, the fixation plate including (i) a contoured portion attached to a planar portion, (ii) an alignment sleeve disposed on the contoured portion, the alignment sleeve including an opening extending at least partially into the contoured portion of the fixation plate, (iii) a security feature disposed on the contoured portion, and (iv) an aperture disposed on the planar portion, the drill guidance apparatus including (i) an engagement surface attached to an extension arm, the engagement surface configured to abut the contoured portion of the fixation plate, (ii) an alignment pin disposed on the engagement portion and configured to be inserted into the alignment sleeve, the alignment pin protruding from the engagement surface, (iii) an attachment feature disposed on the engagement portion, the attachment feature configured to couple with the security feature, (iv) the guidance tube disposed on the extension arm, the guidance tube configured to receive the drill bit therein through a length of the guidance tube, and (v) an extension plate attached to the engagement surface, the extension plate including an aperture, the drill guidance tube being aligned with the aperture of the extension plate;
forming, using the drill bit, a first opening in the dentoalveolar bone;
removing the extension arm and the drill bit;
securing a guidance rod to the aperture of the extension plate through the first opening;
adjusting, using a hollow drill bit inserted over the guidance rod via a hollow portion of the hollow drill bit, a diameter and sidewall structure of the first opening;
removing the hollow drill bit, guidance rod, and drill guidance apparatus; and
securing a dental implant to the aperture of the planar portion of the fixation plate through the adjusted first opening.
